(19) United States
(12) Patent Application Publication
(10) Pub. No.: US 2022/0175014 A1
(43) Pub. Date: Jun. 9, 2022

(54) Method and System for Processing Tobacco

(71) Applicant: JT International S.A., Geneva (CH)

(72) Inventors: Denis Kundid, Trier (DE); Andreas Otto, Newel (DE); Daniel Lickefeld, Riol (DE); Johannes Maerz, Schweich (DE); Dirk Mueller, Schweich (DE)

(73) Assignee: JT International S.A., Geneva (CH)

(21) Appl. No.: 17/440,487

(22) PCT Filed: Mar. 18, 2020
(86) PCT No.: PCT/EP2020/057431

§ 371 Date: Sep. 17, 2021

(30) Foreign Application Priority Data
Apr. 3, 2019 (EP) 19167030.6

(51) Int. Cl. A24B 3/04; F26B 3/26

(52) U.S. Cl. CPC A24B 3/04; F26B 2200/22; F26B 3/26

(57) ABSTRACT

A method for processing tobacco includes providing a first tube having at least one inlet and at least one outlet and having a shape of a helix having a plurality of threads, providing a first motor, generating vibrations, transmitting the vibrations to the first tube, inserting an amount of tobacco, having a first moisture content, into the inlet of the first tube, providing a first air flow through the first tube in a direction from the inlet to the outlet, transporting the amount of tobacco within the first tube towards the outlet of the first tube by the vibrations transmitted to the first tube and by the first air flow, taking out the tobacco at the outlet of the first tube, the tobacco having a second moisture content which is lower than the first moisture content.

### CROSS-REFERENCE TO RELATED APPLICATIONS

The present application is a national phase entry under 35 U.S.C. § 371 of International Application No. PCT/EP2020/057431, filed Mar. 18, 2020, published in English, which claims priority to European Application No. 19167030.6 filed Apr. 3, 2019, the disclosures of which are incorporated herein by reference.

### BACKGROUND OF THE INVENTION

The present invention relates to a method and a system for processing tobacco, according to the preamble of present claims 1 and 15.

After harvesting, tobacco material like tobacco leaves must be dried up to a certain moisture level for further processing. Said moisture level is, for example, dependent on the intended further use of the tobacco. References CN206251926 U and CN206612196 U both relate to methods of tobacco drying. It is known to gradually dry tobacco by placing it within a heated rotating cylinder. This method and other currently available methods of tobacco drying, however, lead to very high degradation and destruction of tobacco material. At low moisture levels, tobacco is known to be fragile and degrading to dust, thereby decreasing the yield.

It is therefore the objective of the invention to provide a method and a system for processing tobacco which allows gentle treatment of the tobacco material, thereby avoiding degradation of the tobacco material.

### BRIEF SUMMARY OF THE INVENTION

The aforementioned problems are solved by a method for processing tobacco, the method comprising the following steps:

providing a first tube having at least one inlet and at least one outlet and comprising a shape of a helix having a plurality of threads,

providing a first motor generating vibrations,

transmitting the vibrations to the first tube,

inserting an amount of tobacco, having a first moisture content, into the inlet of the first tube,

providing a first air flow through the first tube in a direction from the inlet to the outlet,

transporting the amount of tobacco within the first tube towards the outlet of the first tube by the vibrations transmitted to the first tube and by the first air flow,

taking out the tobacco at the outlet of the first tube, the tobacco having a second moisture content which is lower than the first moisture content.

It is preferred that the first tube comprises one single inlet at a first front surface of the first tube and one single outlet at a second front surface of the first tube. It is preferred that, besides the inlet and the outlet, the first tube is free from any other inlets and outlets. It is preferred that the tobacco is able to enter and/or leave the first tube only through the inlet or the outlet.

It is preferred that the amount of tobacco being transported through the first tube within a specific period, that is the tobacco flow rate, is adjustable within a predetermined range. However, it is preferred that the tobacco flow rate for a specific tobacco remains the same for the whole cycle time, that is until the whole batch of tobacco has entered the inlet and left the outlet of the first tube. For example, the tobacco flow rate is adjusted to a value of between 180 and 220 kg/h, preferably to 200 kg/h. By way of example, the first moisture content of the tobacco is 19% (per weight) and/or the second moisture content of the tobacco is 1%.

Vibrations are commonly known to be periodic mechanical oscillations, often comprising a middle or high frequency and/or a low amplitude. The periodicity of the vibration movements applied to the tobacco has proven to ensure a very gentle method of transporting the tobacco with reduced risk of destroying its structure. Besides that, the tobacco is permanently circulated by the vibrations, thereby comprising a high degree of homogeneity with respect to distribution of temperature and residual moisture within the tobacco.

Additionally, the air flow helps to vaporize water and to remove said vaporized water from the tobacco. It is possible that the air flow comprises air having room temperature (for example, 293 K) or air that is preheated up to a specific temperature, for example of between 293 K and 333 K. Furthermore, it is preferred that the air flow rate is adjustable. For example, the air flow rate is adjusted to a value of between 2.0 and 3.0 m/s, preferably to 2.45 m/s.

A helix is known to be a three-dimensional curve winding up at the shell surface of a cylinder with constant slope. Thus, the shape of the tube being a helix reduces the footprint of the tube.

Being of such a helix shape, the first tube comprises an inner diameter and a middle axis having a total length from the inlet to the outlet. It is preferred that a relationship between the total length of the middle axis and the inner diameter of the first tube is within a range of 100 to 140, preferably between 120 and 130. These preferred values mean that the inner diameter of the tube is low, compared with the length of the tube, thereby ensuring that the tobacco can easily come into contact with the wall of the first tube. This helps to effectively transmit the vibrations of the first motor to the tobacco within the first tube and transport the tobacco through the first tube.

Manufacturing such a helix-shaped tube includes, for example, providing a linear tube in the form of a hollow cylinder and winding up said linear tube around a specific winding diameter to form the helix-shaped tube. It is assumed that the dimensions of the linear tube, like the length of the middle axis as well as the inner and the outer diameter, are not affected by the process of winding and are thus equal to the dimensions of the helix-shaped tube being manufactured of said linear tube. Of course, the middle axis of the helix-shaped tube is also helix-shaped, in contrast to the middle axis of the linear tube which comprises the form of a straight line. Alternatively, the helix shaped tube may be formed of an assembly of tubular segments riveted and welded along said middle axis. It may also result from a riveted and welded assembly of complementary curved panels, similarly to the forming of airplanes cabins for instance.

If a virtual winding axis is assigned to the winding diameter of the first tube, the first tube can be arranged such that the virtual middle axis is parallel to a global height direction following the gravity vector. Dependently or independently from that, it is possible that the inlet of the first tube is placed at a position below or above the outlet of the first tube, with respect to the global height direction. If the position of the inlet is placed above the outlet, the tobacco is prevented from moving on through the tube towards the outlet too fast. Thus, exposure time of air flow and vibrations is increased.

The first tube also comprises an outer diameter, wherein a difference between the outer diameter of the first tube and the inner diameter of the first tube equals the wall thickness of the first tube. Preferably, said wall thickness is constant along the middle axis of the first tube and/or in the circumferential direction of the first tube. Preferably, this applies to at least one specific position and most preferably to all positions of the middle axis. Thus, it is preferred that the first tube comprises an overall constant wall thickness.

It is preferred that the first tube comprises a number of threads between 5 and 10, preferably 8 threads. Of course, the number of threads is proportional to the length of the middle axis of the first tube. These values have proven to be high enough to ensure that enough water can be removed from the tobacco on its way through the first tube. At the same time, they have proven to be low enough to ensure that the material costs for such a tube remain within an economic range.

It is preferred that each of the threads is arranged to be in direct contact with one or two of the other threads. This is meant in the axial direction along the middle axis of the first tube and/or in the radial direction of the first tube. Thus, the outer diameter of each of the threads is preferably arranged to be in direct contact with the outer diameter of one or two of the other threads, for example at least along a line. This further helps to reduce space needed for the tube. Moreover, temperature efficiency of the first tube is optimized.

A preferred embodiment of the method comprises the step of providing a heating and controlling a temperature of at least a first section of a wall of the first tube by applying the heating. By controlling the temperature of the wall, it is possible to control the amount of energy which is transmitted to the tobacco and thus the amount of water which is vaporized from the tobacco. Drying time and drying speed can thus be tailored within a desired range.

If the first tube is a metal tube and the heating is a resistance heating, a current can be applied at least to the first section of the wall of the first tube, thereby rendering the control of the temperature of the wall very easy and reliable.

If the first tube comprises a plurality of sections arranged in sequence in relation to the middle axis of the first tube, the temperature of the wall of each of the sections can be controlled individually. This feature takes into account that the moisture level decreases from the inlet to the outlet of the first tube. It is therefore reasonable to adjust the temperature to said moisture level, thereby reducing degradation of the tobacco. Preferably, all sections have the same length.

A preferred embodiment of the method includes conditions wherein the wall of the first tube comprises the first section, a second section and a third section arranged in sequence in relation to the middle axis of the first tube, wherein the temperature of the wall of the first section is equal to the temperature of the wall of the second section and wherein the temperature of the wall of the second section is higher than the temperature of the wall of the third section.

If all three sections have the same length, each length equals one third of the length of the middle axis of the tube. Reducing the temperature at the end of the first tube helps to preserve the structure of desired aromatic agents and thus to maintain a desired aroma within the tobacco. For example, the temperature of the wall of the first section and the temperature of the wall of the second section are both adjusted to 513.15 K and the temperature of the wall of the third section is adjusted to 510.15 K.

Another preferred embodiment of the method according to the present invention includes the step of providing at least one supply port between the inlet and the outlet of the first tube for supplying fresh air to an inside of the first tube. Thus, fresh gas with high water binding capacity can be delivered into the inside of the first tube via the supply port, thereby increasing the speed of tobacco drying. It is possible that the fresh gas delivered into the inside of the first tube via the supply port is air or air with additional components like flavouring agents or the like.

Another preferred embodiment of the method according to the present invention includes the step of providing at least one exhaust port between the inlet and the outlet of the first tube for exhausting vaporized water and/or air. Thus, the humidity of the air within the first tube can be reduced, and the water binding capacity of the air within the first tube can be increased. Besides that, unpleasant odours are removed from the tobacco.

It is preferred that, if a single supply port and a single exhaust port is provided, the exhaust port is arranged between the inlet and the supply port, in a direction along the middle axis of the first tube.

A preferred embodiment includes each of the threads of the first tube comprising one single supply port and/or one single exhaust port. In this case, it is preferred that the first exhaust port is arranged between the inlet and the first supply port, in a direction along the middle axis of the first tube, and that all exhaust ports and all supply ports are arranged in an alternating manner.

It is preferred that the tobacco cannot pass through the supply ports and cannot pass through the exhaust ports.

The method as described may include the step of combusting the exhausted air. Energy derived from said step may be fed back to the method and used for heating up the air flow at a position before the inlet of the first tube. Additionally, unpleasant odour is removed by said step from the exhausted air.

According to a preferred embodiment, the first motor comprises a middle axis, wherein the middle axis of the first motor and the middle axis of the first tube at the inlet of the first tube are arranged towards each other at a mounting angle, wherein the mounting angle, a rotation speed and/or an off-balance of the motor are adjustable within a predetermined range. Said parameters are suitable to influence the frequency and/or the amplitude of the vibrations, for example. If necessary, the vibrations can be omitted by switching off the motor according to a predeterminable time scheme. Thus, the needs of a lot of different types of tobacco can be fulfilled.

According to preferred parameters, the mounting angle is adjustable within a range of between 10° and 30°, the rotation speed is adjustable within a range of between 400 and 1000 rpm, and/or the off-balance of the motor is adjustable within a range of 0 to 100%. By way of example, the mounting angle is adjusted to 22°, the rotation speed is adjusted to 740 rpm and/or the off-balance of the motor is adjusted to 75%.

It is known that drying the tobacco up to a specific moisture content helps to remove all unpleasant odours from the tobacco. However, for further processing of the tobacco, it is sometimes necessary to increase the moisture content of the tobacco afterwards again, thereby reducing the risk of tobacco degradation.

Thus, it is suggested a preferred embodiment of the method, wherein the method further comprises the steps of

providing a second tube having at least one inlet and at least one outlet,

providing a second motor generating vibrations,

transmitting the vibrations generated by the second motor to the second tube,

providing a second air flow through the second tube starting at the inlet of the second tube, connecting the first tube and the second tube in series,

inserting the tobacco, coming from the outlet of the first tube and having the second moisture content, into the inlet of the second tube,

providing water to the tobacco at a position before the inlet of the second tube and/or at a position between the inlet and the outlet of the second tube,

transporting the tobacco within the second tube towards the outlet of the second tube,

taking out the tobacco at the outlet of the second tube, the tobacco having a third moisture content which is lower than the first moisture content and higher than the second moisture content.

It is assumable that the second tube can comprise at least one feature as described above with respect to the first tube. It is possible that the first and the second tube are identical or are different, for example with respect to at least one of their dimensions. It is possible that the parameters chosen for the second tube, like motor speed or air flow rate, are the same or are different to the parameters chosen for the first tube.

It is possible that, with respect to the global height direction, the first and the second tube are arranged above each other, most preferred with the second tube being arranged above the first tube. Besides that, it is preferred that at least one, preferably both of the first and the second tube are arranged such that each of their virtual winding axes is arranged parallel to the global height direction. It is possible that the virtual winding axis of the first tube is parallel to the virtual winding axis of the second tube and arranged with a distance towards the virtual winding axis of the second tube. Alternatively, it is possible that the virtual winding axis of the first tube is aligned with the virtual winding axis of the second tube.

For easily connecting both tubes, it is preferred that a connecting tube or connecting hose is arranged between the outlet of the first tube and the inlet of the second tube.

The objective is also reached by a system for processing tobacco,

comprising

a first tube and a second tube, each having at least one inlet and at least one outlet and comprising a shape of a helix having a plurality of threads, wherein the first tube and the second tube are connected in series,

a first motor and a second motor, each generating vibrations, wherein the vibrations generated by the first motor are transmittable to the first tube and wherein the vibrations generated by the second motor are transmittable to the second tube,

a first air flow through the first tube and a second air flow through the second tube, each starting at the inlet of the first or second tube,

a heating for controlling a temperature of at least a section of a wall of the first tube,

wherein an amount of tobacco is transportable through the first tube and the second tube in sequence,

at least one supply port between the inlet and the outlet of the first tube for supplying fresh air to the inside of the first tube,

at least one exhaust port between the inlet and the outlet of the first tube for exhausting vaporized water and/or air,

a water source delivering water to the tobacco at a position before the inlet of the second tube and/or at a position between the inlet and the outlet of the second tube.

For all preferred embodiments of the method as described herein, it is possible that one or more of the features as described with respect to the system are used. For all preferred embodiments of the system as described herein, it is possible that one or more of the features as described with respect to the method are used.

### BRIEF DESCRIPTION OF THE DRAWINGS

Further advantages, objectives and features of the present invention will be described, by way of example only, in the following description with reference to the appended figures. In the figures, similar components in different embodiments can exhibit the same reference symbols.

The figures show:

FIG. 1 a schematic view of preferred embodiments of the method according to the present invention;

FIG. 2a a schematic view of a first system used within the method according to the present invention;

FIG. 2b a schematic view of a second system used within the method according to the present invention;

FIG. 3a a cross sectional view of the first tube according to FIG. 2;

FIG. 3b a front view of a linear tube for manufacturing a helix-shaped tube;

FIG. 3c an illustration of temperature control along the length of the middle axis of the first tube.

### DETAILED DESCRIPTION

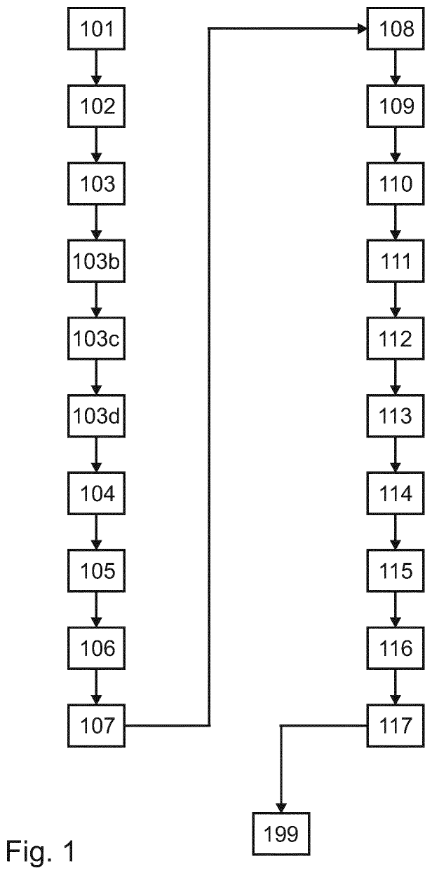

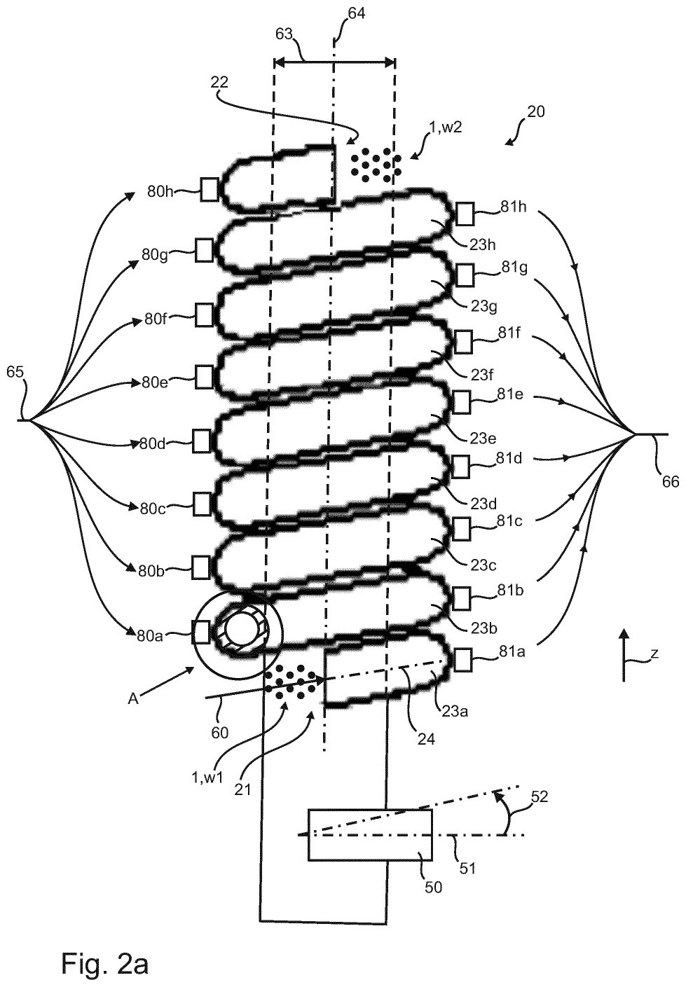

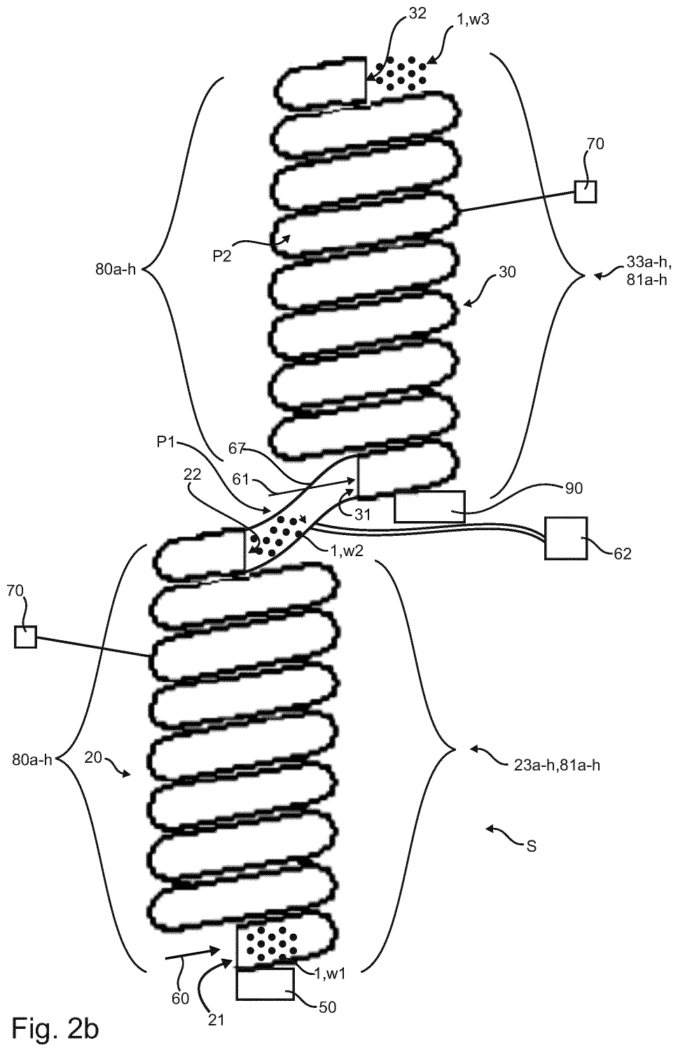

FIG. 1 shows an overview of a preferred embodiment of the method 100 for processing tobacco 1 according to the present invention. FIG. 2a shows a preferred embodiment of the first tube 20.

The method 100 comprises the following steps:

(101) providing a first tube 20 having at least one inlet 21 and at least one outlet 22 and comprising a shape of a helix having a plurality of threads 23a-h,

(102) providing a first motor 50, generating vibrations,

(103) transmitting the vibrations to the first tube 20,

(104) inserting an amount of tobacco 1, having a first moisture content w1, into the inlet 21 of the first tube 20,

(105) providing a first air flow 60 through the first tube 20 in a direction from the inlet 21 to the outlet 22,

(106) transporting the amount of tobacco 1 within the first tube 20 towards the outlet 22 of the first tube 20 by the vibrations transmitted to the first tube 20 and by the first air flow 60,

(107) taking out the tobacco 1 at the outlet 22 of the first tube 20, the tobacco 1 having a second moisture content w2 which is lower than the first moisture content w1.

FIG. 2a shows that the first tube 20 comprises one single inlet 21 at a first front surface of the first tube 20 and one single outlet 22 at a second front surface of the first tube 20. Besides that, the first tube 20 is free from any other inlets and outlets. The tobacco 1 is able to enter and/or leave the first tube 20 only through the inlet 21 or the outlet 22.

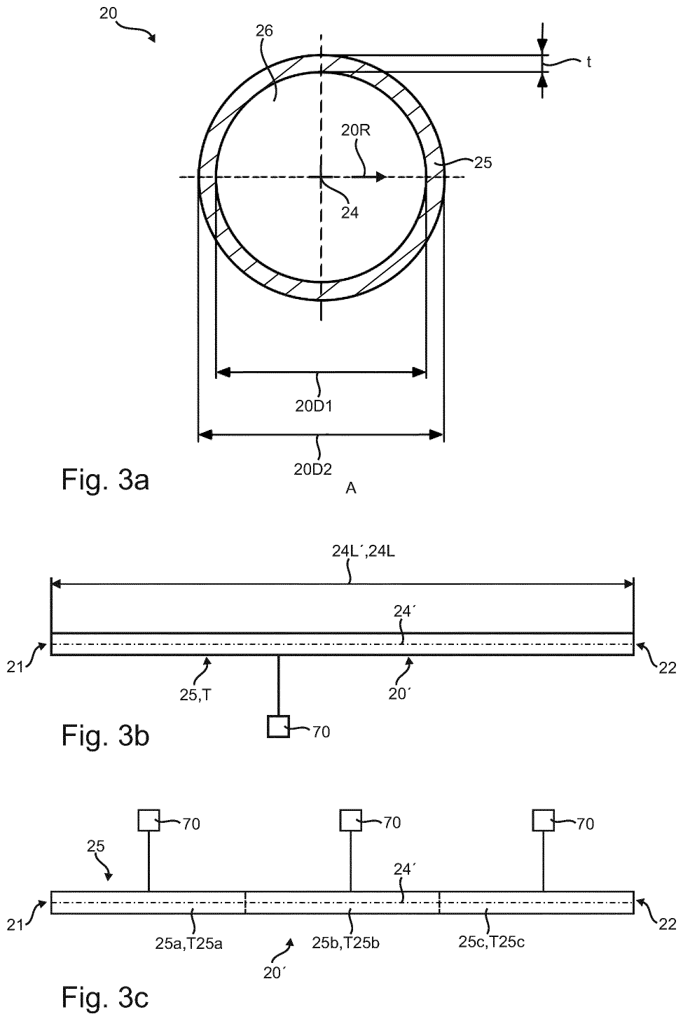

FIG. 3a shows a cross section of a part (see portion A as marked in FIG. 2a) of the first tube 20. It is shown that the first tube 20 comprises an inner diameter 20D1 and a middle axis 24. Moreover, the first tube 20 also comprises an outer diameter 20D2, wherein a difference between the outer diameter 20D2 of the first tube 20 and the inner diameter 20D1 of the first tube 20 equals the wall thickness t of the first tube 20. In this case, the first tube 20 comprises an overall constant wall thickness t. FIG. 3a also shows an inside 26 of the first tube which represents the area between the middle axis 24 and the inner diameter 20D1, with respect to a radial direction 20R of the first tube 20. A relationship between the total length 24L of the middle axis 24 and the inner diameter 20D of the first tube 20 is within a range of 120 to 130.

A virtual winding axis 64 is assigned to the winding diameter 63 of the first tube 20. As shown by FIG. 2a, the first tube 20 is arranged such that the virtual middle axis 64 is parallel to a global height direction z following the gravity vector. The inlet 21 of the first tube 20 is placed at a position below the outlet 22 of the first tube 20, with respect to the global height direction z.

In this case, the first tube 20 comprises 8 threads 23a-h. Each one of the threads 23a-h is arranged to be in direct contact with one or two of the other threads 23a-h. Due to the helix shape, the first thread 23a and the last thread 23h are each arranged to be in direct contact with only one 23b, 23g of the other threads 23a-h. All other threads 23b-g are arranged to be in direct contact with two of the other threads 23a-h. In this case, the outer diameter 20D2 of each of the threads 23a-h is arranged to be in direct contact with the outer diameter 20D2 of one or two of the other threads 23a-h.

FIGS. 3b and 3c show two embodiments of a linear tube 20′ which is used for manufacturing the helix-shaped first tube 20 as shown by FIG. 2a. Said linear tube 20′ comprises the form of a hollow cylinder and is winded up around a specific winding diameter 63 (see FIG. 2a) to form the helix-shaped first tube 20. It is assumed that the dimensions of the linear tube 20′, like the length 24L′ of the middle axis 24′ as well as the inner diameter and the outer diameter, are not affected by the process of winding and are thus equal to the dimensions of the helix-shaped tube 20 being manufactured of said linear tube, like the length 24L of the middle axis 24 as well as the inner diameter 20D1 and the outer diameter 20D2. Of course, the middle axis 24 of the helix-shaped tube 20 is also helix-shaped (see FIG. 2a), in contrast to the middle axis 24′ of the linear tube 20′ which comprises the form of a straight line.

For the sake of clarity, some preferred features are thus explained with respect to the example of the linear tube 20′, as shown by FIGS. 3b and 3c. If not explicitly mentioned, all features explained with respect to the example of the linear tube 20′ also apply to the helix-shaped first tube 20.

According to FIG. 1, the method 100 further comprises the step of (103b) providing a heating 70 and controlling a temperature T of at least a first section 25a of a wall 25 of the first tube 20, 20′ by applying the heating 70 (see FIG. 3b). In this case, the first tube 20, 20′ is a metal tube and the heating 70 is a resistance heating.

FIG. 3c shows that the first tube 20, 20′ comprises a plurality of sections 25a, 25b, 25c arranged in sequence in relation to the middle axis 24, 24′ of the first tube 20, 20′. Thus, the temperature T25a, T25b, T25c of the wall 25 of each of the sections 25a, 25b, 25c can be controlled individually. All sections 25a, 25b, 25c have the same length (of one third of the length 24L, 24L′). In this case, the temperature T25a of the wall 25 of the first section 25a is equal to a temperature T25b of the wall 25 of the second section 25b and wherein the temperature T25b of the wall 25 of the second section 25b is higher than the temperature 25c of the wall 25 of the third section 25c.

FIG. 1 shows that in this case, the method 100 includes the step of (103c) providing a plurality of supply ports 80a-h between the inlet 21 and the outlet 22 of the first tube 20 for supplying fresh air 65 to an inside 26 of the first tube 20. Furthermore, FIG. 1 shows that in this case, the method 100 includes the step of (103d) providing a plurality of exhaust ports 81a-h between the inlet 21 and the outlet 22 of the first tube 20 for exhausting a mixture 66 of vaporized water and air. More precisely, each of the threads 23a-h of the first tube 20 comprises one single supply port 80a-h and one single exhaust port 81a-h. In this case, the first exhaust port 81a is arranged between the inlet 21 and the first supply port 80a, in a direction along the middle axis 24 of the first tube 20. Moreover, all exhaust ports 81a-h and all supply ports 80a-h are arranged in an alternating manner between the inlet 21 and the outlet 22, following the order: inlet 21, first exhaust port 81a, first supply port 80a, second exhaust port 81b, second supply port 80b, . . . , eighth exhaust port 81h, eighth supply port 80h, outlet 22.

Additionally, FIG. 1 shows that the method 100 includes the step of (108) combusting the exhausted air.

FIG. 2a shows that the first motor 50 comprises a middle axis 51, wherein the middle axis 51 of the first motor 50 and the middle axis 24 of the first tube 20 at the inlet 21 of the first tube 20 are arranged towards each other at a mounting angle 52. In this case, the mounting angle 52, a rotation speed and an off-balance of the motor 50 are adjustable within a predetermined range.

FIG. 1 shows that the method 100 further comprises the steps of

(109) providing a second tube 30 (see also FIG. 2b) having at least one inlet 31 and at least one outlet 32,

(110) providing a second motor 90, generating vibrations,

(111) transmitting the vibrations generated by the second motor 90 to the second tube 30,

(112) providing a second air flow 61 through the second tube 30, starting at the inlet 31 of the second tube 30,

(113) connecting the first tube 20 and the second tube 30 in series,

(114) inserting the tobacco 1, coming from the outlet 22 of the first tube 20 and having the second moisture content w2, into the inlet 31 of the second tube 30,

(115) providing water to the tobacco 1 at a position P1 before the inlet 31 of the second tube 30,

(116) transporting the tobacco 1 within the second tube 30 towards the outlet 31 of the second tube 30,

(117) taking out the tobacco 1 at the outlet 32 of the second tube 30, the tobacco 1 having a third moisture content w3 which is lower than the first moisture content w1 and higher than the second moisture content w2.

The end of the method is marked with (199).

In this case, the first 20 and the second tube 30 are identical. For easily connecting both tubes, FIG. 2c shows that a connecting hose 67 is arranged between the outlet 22 of the first tube 20 and the inlet 31 of the second tube 30.

The objective is also reached by a system S for processing tobacco 1 (see FIG. 2b),

comprising

a first tube 20 and a second tube 30, each having one single inlet 21; 31 and one single outlet 22, 32 and comprising a shape of a helix having a plurality of threads 23a-h, 33a-h,

wherein the first tube 20 and the second tube 30 are connected in series,

a first motor 50 and a second motor 90, each generating vibrations, wherein the vibrations generated by the first motor 50 are transmittable to the first tube 20 and wherein the vibrations generated by the second motor 90 are transmittable to the second tube 30,

a first air flow 60 through the first tube 20 and a second air flow 61 through the second tube 30, each starting at the inlet 21; 31 of the first 20 or second tube 30,

a heating 70 for controlling a temperature T of at least a section 25a of a wall 25 of each of the first tube 20 and the second tube 30 (see also FIGS. 3b and 3c),

wherein an amount of tobacco 1 is transportable through the first tube 20 and the second tube 30 in sequence,

a plurality of supply ports 80a-h between the inlet 21 and the outlet 22 of the first tube 20 and between the inlet 31 and the outlet 32 of the second tube 30 for supplying fresh air 65 to an inside 26 of the first tube 20 and the second tube 30,

a plurality of exhaust ports 81a-h between the inlet 21 and the outlet 22 of the first tube 20 and between the inlet 31 and the outlet 32 of the second tube 30 for exhausting vaporized water and/or air 66,

a water source 62 delivering water to the tobacco 1 at a position P1 before the inlet 31 of the second tube 30 (FIG. 1 also indicates an alternative position P2 between the inlet 31 and the outlet 32 of the second tube 30).

The applicant reserves his right to claim all features disclosed in the application document as being an essential feature of the invention, as long as they are new, individually or in combination, in view of the prior art. Furthermore, it is noted that in the figures, features are described which can be advantageous individually. Someone skilled in the art will directly recognize that a specific feature being disclosed in a figure can be advantageous also without the adoption of further features from this figure. Furthermore, someone skilled in the art will recognize that advantages can evolve from a combination of diverse features being disclosed in one or various figures.

### LIST OF REFERENCE SIGNS

1 tobacco
20, 20′, 30 tube
20D1 inner diameter
20D2 outer diameter
21, 31 inlet
22, 32 outlet
23a-h, 33a-h thread
24, 24′, 51 middle axis
24L, 24L′ length
25 wall
25a-c section
26 inside
50, 90 motor
52 mounting angle
60, 61 air flow
62 water source
63 winding diameter
64 winding axis
65 fresh air
66 mixture
67 connecting hose
70 heating
80a-h supply port
81a-h exhaust port
100 method
101-117 step
199 end
P1, P2 position
T, T25a-c temperature
S system
w1, w2, w3 moisture content
z global height direction

1. A method for processing tobacco,
the method comprising the following steps:
providing a first tube having at least one inlet and at least one outlet and comprising a shape of a helix having a plurality of threads,
providing a first motor, generating vibrations,
transmitting the vibrations to the first tube,
inserting an amount of tobacco, having a first moisture content, into the at least one inlet of the first tube,
providing a first air flow through the first tube in a direction from the at least one inlet to the at least one outlet,
transporting the amount of tobacco within the first tube towards the at least one outlet of the first tube by the vibrations transmitted to the first tube and by the first air flow,
taking out the tobacco at the at least one outlet of the first tube, the tobacco having a second moisture content which is lower than the first moisture content.

2. The method according to claim 1,
wherein the first tube comprises an inner diameter and a middle axis having a total length from the at least one inlet to the at least one outlet, wherein a ratio of the total length of the middle axis to the inner diameter of the first tube is within a range of 100 to 140.

3. The method according to claim 1,
wherein the plurality of threads of the first tube comprises between 5 and 10 threads.

4. The method according to claim 1,
wherein each thread of the plurality of threads is arranged to be in contact with one or two other threads of the plurality of threads.

5. The method according to claim 1,
further comprising the step of:
providing a heating and controlling a temperature of at least a first section of a wall of the first tube by applying the heating.

6. The method according to claim 5,
wherein the first tube is a metal tube and the heating is a resistance heating, wherein a current is applied at least to the first section of the wall of the first tube.

7. The method according to claim 5,
wherein the wall of the first tube comprises a plurality of sections including the first section, the plurality of sections arranged in sequence in relation to the middle axis of the first tube, wherein the temperature of the wall of each of the plurality of sections is controlled individually.

8. The method according to claim 7,
wherein the plurality of sections includes the first section, a second section and a third section arranged in sequence in relation to the middle axis of the first tube, wherein the temperature of the wall of the first section is equal to the temperature of the wall of the second section, and wherein the temperature of the wall of the second section is higher than the temperature of the wall of the third section.

9. The method according to claim 1,
further comprising the step of:
providing at least one supply port between the at least one inlet and the at least one outlet of the first tube for supplying fresh air to an inside of the first tube.

10. The method according to claim 9,
further comprising the step of:
providing at least one exhaust port between the at least one inlet and the at least one outlet of the first tube for exhausting vaporized water and/or air.

11. The method according to claim 10,
wherein each thread of the plurality of threads of the first tube comprises one single supply port of the at least one supply port and/or one single exhaust port of the at least one exhaust port.

12. The method according to claim 10,
further comprising the step of:
combusting the exhausted air.

13. The method according to claim 1,
wherein the first motor comprises a middle axis,
wherein the middle axis of the first motor and the middle axis of the first tube at the at least one inlet of the first tube are arranged towards each other at a mounting angle,
wherein the mounting angle, a rotation speed and/or an off-balance of the motor are adjustable within a predetermined range.

14. The method according to claim 1,
further comprising the steps of:
providing a second tube having at least one inlet and at least one outlet,
providing a second motor, generating vibrations,
transmitting the vibrations generated by the second motor to the second tube,
providing a second air flow through the second tube, starting at the at least one inlet of the second tube,
connecting the first tube and the second tube in series,
inserting the tobacco, coming from the at least one outlet of the first tube and having the second moisture content, into the at least one inlet of the second tube,
providing water to the tobacco at a position before the at least one inlet of the second tube and/or at a position between the at least one inlet of the second tube and the at least one outlet of the second tube,
transporting the tobacco within the second tube towards the at least one outlet of the second tube,
taking out the tobacco at the at least one outlet of the second tube, the tobacco having a third moisture content which is lower than the first moisture content and higher than the second moisture content.

15. A system for processing tobacco,
comprising
a first tube and a second tube each having at least one at least one inlet and at least one at least one outlet and comprising a shape of a helix having a plurality of threads, wherein the first tube and the second tube are connected in series,
a first motor and a second motor, each generating vibrations, wherein the vibrations generated by the first motor are transmittable to the first tube and wherein the vibrations generated by the second motor are transmittable to the second tube,
a first air flow through the first tube and a second air flow through the second tube, each starting at the at least one inlet of the first tube or of the second tube, respectively,
a heating for controlling a temperature of at least a first section of a wall of the first tube and/or the second tube,
wherein an amount of tobacco is transportable through the first tube and the second tube in sequence,
at least one supply port between the at least one inlet of the first tube and the at least one outlet of the first tube and/or between the at least one inlet of the second tube and the at least one outlet of the second tube for supplying fresh air to an inside of the first tube or the second tube, respectively,
at least one exhaust port between the at least one inlet of the first tube and the at least one outlet of the first tube and/or between the at least one inlet of the second tube and the at least one outlet of the second tube for exhausting vaporized water and/or air,
a water source delivering water to the tobacco at a position before the at least one inlet of the second tube and/or at a position between the at least one inlet of the second tube and the at least one outlet of the second tube.

16. The method according to claim 2,
wherein the ratio of the total length of the middle axis to the inner diameter of the first tube is between 120 and 130.

17. The method according to claim 3,
wherein the plurality of threads of the first tube comprises 8 threads.
